(19) United States
(12) Patent Application Publication
(10) Pub. No.: US 2003/0041980 A1
(43) Pub. Date: Mar. 6, 2003

(54) Cable tensioner for a door

(76) Inventors: Peter S. Schulte, East Dubuque, IL (US); Robert J. Harter, LaCrosse, WI (US)

Correspondence Address: MARSHALL, GERSTEIN & BORUN, 6300 SEARS TOWER, 233 SOUTH WACKER, CHICAGO, IL, 60606-6357, US

(21) Appl. No.: 09/947,616

(22) Filed: Sep. 6, 2001

(51) Int. Cl. E05F 11/00

(52) U.S. Cl. 160/193

(57) ABSTRACT

A cable tensioner for an industrial door helps keep a cable neatly wrapped on its take-up drum. In some embodiments, the tensioner functions in a first mode during normal door operation, and operates in a second mode when the tension in the cable decreases to a predetermined low level. When operating in the second mode, the tensioner is able to take up slack in a cable that supports a door member, such as a door panel or a deadweight that counteracts the door panel's weight. The tensioner may be adapted for use on various doors including, but not limited to, sectional doors, roll-up doors, high-lift doors, horizontally storing doors, vertically storing doors, and various combinations thereof.

### BACKGROUND OF THE INVENTION

1. Field of the Invention

The subject invention generally pertains to industrials doors and more specifically to a cable tensioner for such a door.

2. Description of Related Art

Sectional doors and rollup doors are two common examples of an industrial door. Sectional doors are often used as residential garage doors; however, they are also often used in warehouses and other industrial buildings. A sectional door typically includes a series of panels whose adjacent horizontal edges are connected by hinges. As the door opens or closes, the door panels travel along two lateral tracks. The tracks typically include a vertical section and an overhead section with a transitional curved section between the two. To close the door, the tracks guide the panels to a vertical position across the doorway. When the door opens, the hinges allow at least some of the panels to curve around onto the overhead section of the tracks. Such doors can be powered open and closed or moved manually.

To fit a sectional door underneath a standard 8-foot high ceiling of a typical residential garage, the vertical section of tracks is of limited height and the overhead section of tracks is generally horizontal. However, to take full advantage of generally higher ceilings in warehouses and other industrial buildings, a certain types of sectional doors known as a “high-lift” or “vertical lift” may be used. With a vertical-lift sectional door, the vertical section of tracks is extended and the overhead section may be nearly vertical or lie at an incline, such as a 15-degree incline from horizontal. The nearly vertical or inclined overhead section plus the extra vertical section provides greater clearance for material handling equipment, parts, and other equipment that may need to pass underneath the overhead tracks. With high-lift doors, one or more panels may store in the vertical and/or curved section of tracks when the door is at its fully open position.

A roll-up door typically includes a pliable roll-up panel or curtain that is wound about an overhead roller. Some roll-up panels are made of flexible fabric reinforced with several vertically spaced horizontal stays or wind bars. Other roll-up panels comprise a series of narrow, relatively rigid metal bars or segments that extend horizontally across the doorway. The segments are pivotally interconnected along their horizontal edges, so that the panel can wrap around the overhead roller.

To close a roll-up door, the roller pays out the panel as two vertical tracks along either side edge of the doorway guide the side edges of the panel generally along a vertical plane across the doorway. The rotation of the roller is reversed to open the door. Roll-up doors are typically either powered open and closed, or are powered open and allowed to close by gravity.

To ease the operation of a vertically moving door, a counterbalance system is often used to counteract the weight of the door panel or panels. Counterbalance systems typically include one or more deadweights or a spring. When deadweights are used, they are usually suspended from a cable that is wrapped about a drum fixed to an overhead rotatable shaft. Another drum fixed to that same shaft holds another cable that carries the weight of the door panels. The cable attached to the door panels and the cable attached to the deadweights are wrapped about their respective drums in opposite directions to create two opposing torques that are applied to the overhead shaft. With the two torques acting in opposite directions, the weights of the door panels and the deadweights generally cancel each other, which makes it easier to open and close the door. Doors with a counterbalance system employing a torsion spring operate in a similar manner; however, the torsion spring applies a torque to the overhead shaft that replaces the torque otherwise created by the cable-suspended deadweight.

To keep a cable neatly wrapped about its drum and to prevent the cable from getting tangled by overlapping itself, a drum may include a cable groove that runs helically around the drum. The groove creates a helical track that helps guide the cable in a similar helical pattern as the cable wraps and unwraps about the drum. This works well as long as the cable is maintained in sufficient tension. Under certain circumstances, however, the tension in a cable may be momentarily released, which can create sufficient slack in the cable to allow the cable to “jump a groove” and get tangled with itself on the drum. This can damage a cable, cause a door to jerk unexpectedly, or even prevent operation of the door until maintenance personnel corrects the problem. In severe cases, the cable may even jump completely off the drum.

There are many situations, some of which may be unknown, which can cause a momentary release of cable tension. When opening a door, for example, momentum may carry the door panel beyond its normal open position. This may momentarily unload the door's counterbalance system by lowering a deadweight onto the floor or by releasing the preload on a counterbalance's torsion spring. Or if a door is slammed shut, the door panel may come to an abrupt stop upon hitting the floor. Meanwhile, the angular momentum of the overhead shaft may allow the drum that supports the door panel to continue releasing cable. At the same time, the upward momentum of a deadweight may allow the deadweight to continue traveling upward, which could release the tension in the deadweight's cable as well. A cable can also become slack if whatever it is carrying (door panel or deadweight) gets snagged or caught upon traveling downward. In general, the cable that supports either the door panel or a deadweight may become slack and jump a groove whenever the relative speed or position of the deadweight and the door panel is mismatched.

### SUMMARY OF THE INVENTION

In some embodiments, a door includes a counterbalance system with tensioner that may help keep a cable or other flexible elongated member on a rotatable drum.

In some embodiments, the counterbalance system includes a torsion spring or a suspended deadweight that helps offset the weight of a door panel.

In some embodiments, the tensioner is connected to the flexible elongated member.

In some embodiments, the tensioner is disposed between the rotatable drum and where the flexible elongated member attaches to the door panel or the deadweight.

In some embodiments, the tensioner moves up as the door opens.

In some embodiments, the tensioner moves down as the door opens.

In some embodiments, the tensioner includes a resilient member, such as a tension spring, compression spring, torsion spring, gas spring, or an elastic cord.

In some embodiments, the door is a sectional door that includes a plurality of interconnected door panels.

In some embodiments, the door is a rollup door, wherein the door panel wraps about a drum as the door opens. In some embodiments, the resilient member selectively operates in a first mode under certain conditions and operates in a second mode under other conditions.

### BRIEF DESCRIPTION OF THE DRAWINGS

FIG. 1 is a front view of a sectional door in a closed position, as viewed from inside a building, and showing a tensioner coupled to the door's counterbalance system.

FIG. 2 is a right side view of FIG. 1.

FIG. 3 is the similar to FIG. 1, but with the door open.

FIG. 4 is a right side view of FIG. 3.

FIG. 5 is a front view of a rollup door in a closed position, as viewed from inside a building, and showing a tensioner coupled to the door's counterbalance system.

FIG. 6 is similar to FIG. 5, but with the door open.

FIG. 7 is a front view of another rollup door in a closed position, as viewed from inside a building, and showing a tensioner coupled to the door's counterbalance system.

FIG. 8 is a front view of another rollup door in a closed position, as viewed from inside a building, and showing a tensioner coupled to the door's counterbalance system.

FIG. 9 is a front view of another rollup door in a closed position, as viewed from inside a building, and showing a tensioner coupled to the door's counterbalance system.

FIG. 10 is a front view of another sectional door in a closed position, as viewed from inside a building, and showing a tensioner coupled to the door's counterbalance system.

FIG. 11 is similar to FIG. 10, but with the door open.

FIG. 12 is a close up view of the tensioner in the position shown in FIG. 10.

FIG. 13 is a close up view of the tensioner in the position shown in FIG. 11.

### DESCRIPTION OF THE PREFERRED EMBODIMENT

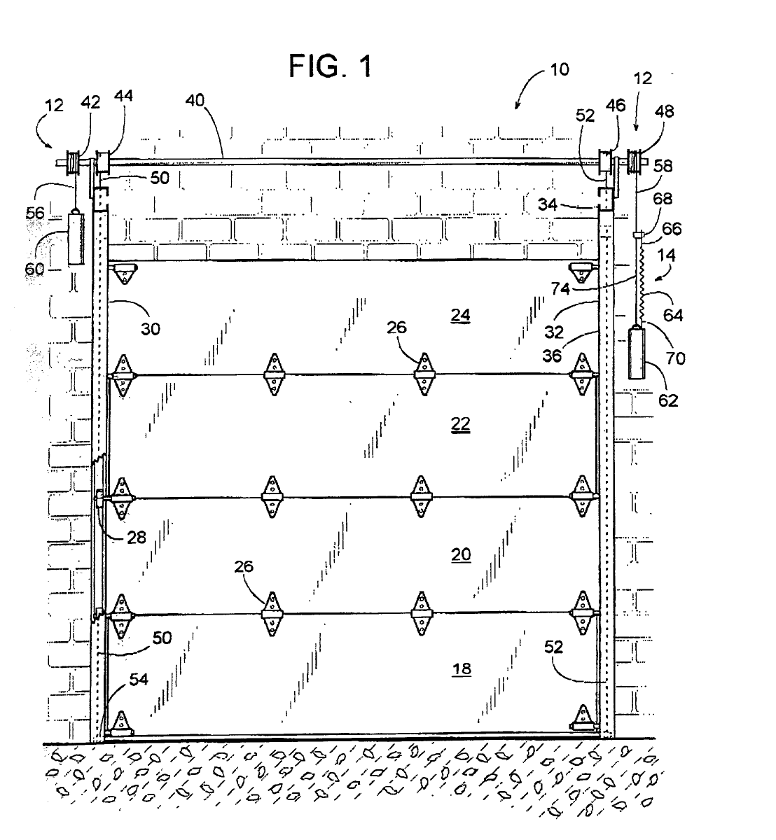

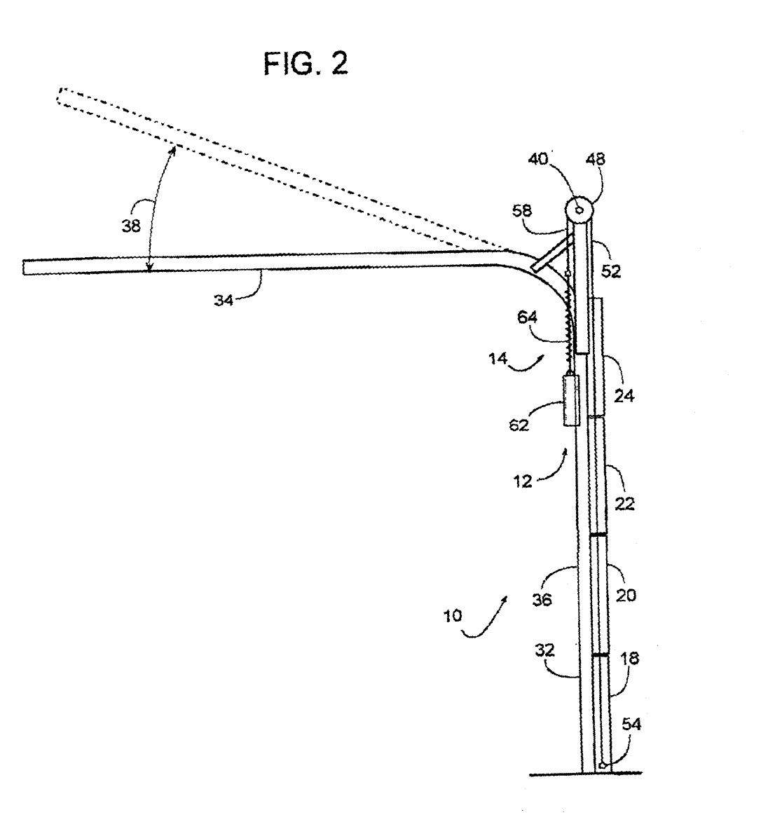

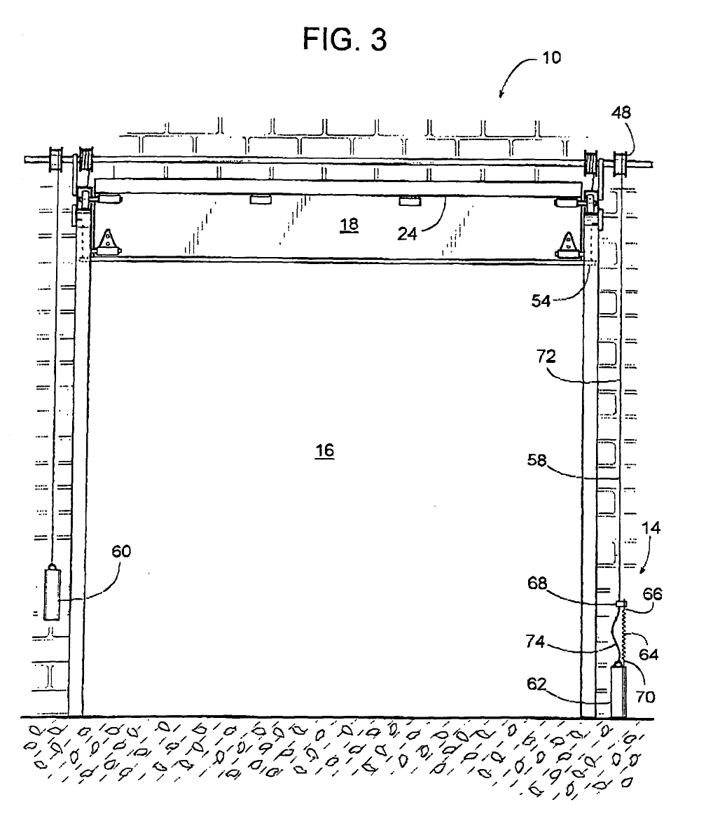

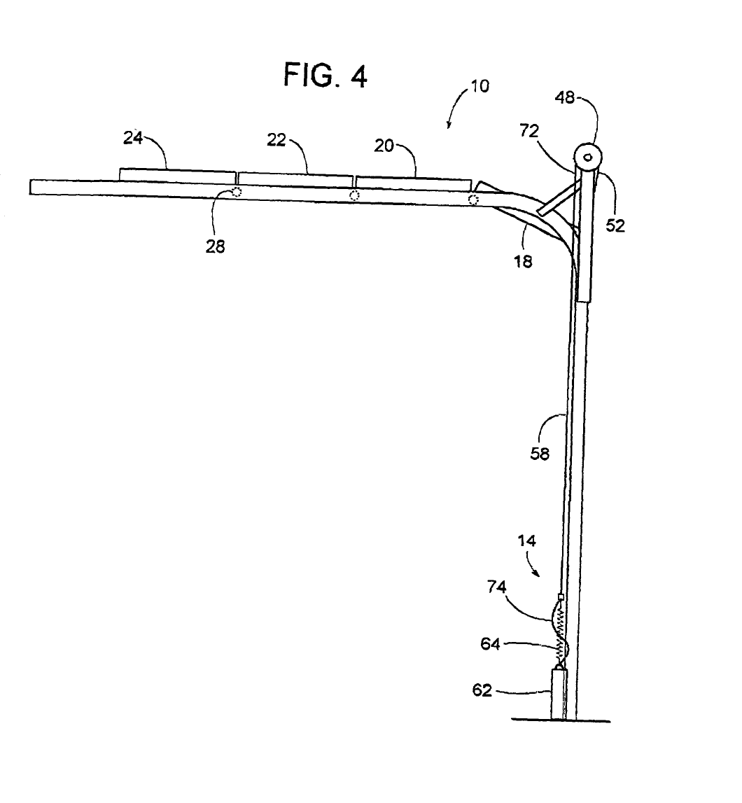

A sectional door 10, shown closed in FIGS. 1 and 2 and open in FIGS. 3 and 4, is just one example of a vertically moveable door. Door 10 includes a counterbalance system 12 that helps counterbalance at least some of the weight of the door's door panels. Door 10 also includes a tensioner 14 that helps maintain various flexible elongated members of counterbalance system 12 taut during certain operating conditions. The term, “counterbalance system” refers to any apparatus that includes a deadweight or a spring (e.g., torsion spring) working in conjunction with a flexible elongated member (e.g., a cable, chain, strap, cord, rope, etc.) for carrying or countering at least some of the weight of a door's panel as the door moves between its open and closed positions. The term, “door panel” refers to any member that is moveable to selectively cover and uncover at least part of a doorway opening (e.g., doorway 16). A door panel may be a generally rigid, planar member or a pliable sheet and may be a unitary piece or comprise a plurality of interconnected panel segments.

For the embodiment of FIGS. 1-4, door 10 includes a series of door panels 18, 20, 22 and 24 that are interconnected along their adjacent horizontal edges by hinges 26. As door 10 opens or closes, guide members, such as rollers 28, guide the movement of the panels along two lateral tracks 30 and 32, which curve between upper and lower sections 34 and 36 respectively. In this example, upper section 34 is horizontal, as shown in FIG. 2. In other embodiments, however, upper section 34 may be at any angle 38 ranging from zero-degrees (horizontal) to 90-degrees (vertical). To close door 10, the lower track sections 36 guide the door panels to a vertical position across doorway 16. When door 10 opens, hinges 26 allow the panels to curve around onto upper track section 34, where the door panels store overhead. Door 10 can be power operated or open and closed manually.

To reduce the force required to lift the door panels to their open position, counterbalance system 12 comprises a rotatable shaft 40 to which four drums 42, 44, 46 and 48 are fixed. Two cables 50 and 52, or some other type of flexible elongated member, are wrapped around and fastened to drums 44 and 46 respectively. The lower ends of cables 50 and 52 are coupled to door panel 18 by way of an anchor 54 or some type of fastener. Another pair of flexible elongated members, such as cables 56 and 58 are wrapped around and fastened to drums 42 and 48 respectively. Deadweights 60 and 62 are suspended from the lower ends of cables 56 and 58. Cables 56 and 58 wrap around drums 42 and 48 in a direction opposite to that which cables 50 and 52 wrap around drums 44 and 46. As door 10 is moved between its open and closed positions, deadweights 60 and 62 hanging from cables 56 and 58, and door panels 18, 20, 22 and 24 hanging from cables 50 and 52 create two opposing torques that are applied to shaft 40. With the two torques acting in opposite directions, the weight of the door panels and deadweights help cancel each other, which makes it easier to open and close the door. Depending on the relative weight of the deadweights and the door panels, door 10 may not necessarily be perfectly balanced, but instead the door may be biased open or closed.

As door 10 opens, the door panels sequentially move onto the upper section of tracks 34, which help support the weight of those panels. This relieves some of the tension in cables 50 and 52. To reduce the counter tension in cables 56 and 58 accordingly, deadweight 62 may be lowered down onto the floor, as shown in FIGS. 3 and 4. This occurs automatically, as deadweight 62 is lower than deadweight 60. As deadweight 62 reaches the floor, cable 58 may become slack.

To prevent the cable slackness from allowing cable 58 to lift off of drum 48, tensioner 14 is coupled to cable 58 between deadweight 62 and drum 48 to maintain an acceptable amount of tension in cable 58. In this particular embodiment, tensioner 14 comprises a resilient member, such as a tension spring 64. An upper end 66 of spring 64 attaches to cable 58 by way of a cable clamp 68 or some other type of fastener, and a lower end 70 of spring 64 attaches to deadweight 62. Spring 64 is stretched (i.e., prestressed) by deadweight 62 hanging from cable 58, as shown in FIGS. 1 and 2. As the weight of deadweight 62 is unloaded from cable 58, as shown in FIGS. 3 and 4, spring 64 retracts to maintain a certain amount of tension in an upper portion 72 of cable 58, while only a lower portion 74 of cable 58 becomes slack. The tension that spring 64 creates in cable 58 is above a threshold level sufficient to help hold cable 58 snugly against drum 48. Tension spring 64 operates in a first mode (the length of spring 64 remains constant) when the dynamic load in cable 58 is above the predetermined load, as shown in FIGS. 1 and 2. Tension spring 64 operates in a second mode (the spring retracts) when the tension (or dynamic load) in cable 58 is below a predetermined load (e.g., three pounds), as shown in FIGS. 3 and 4.

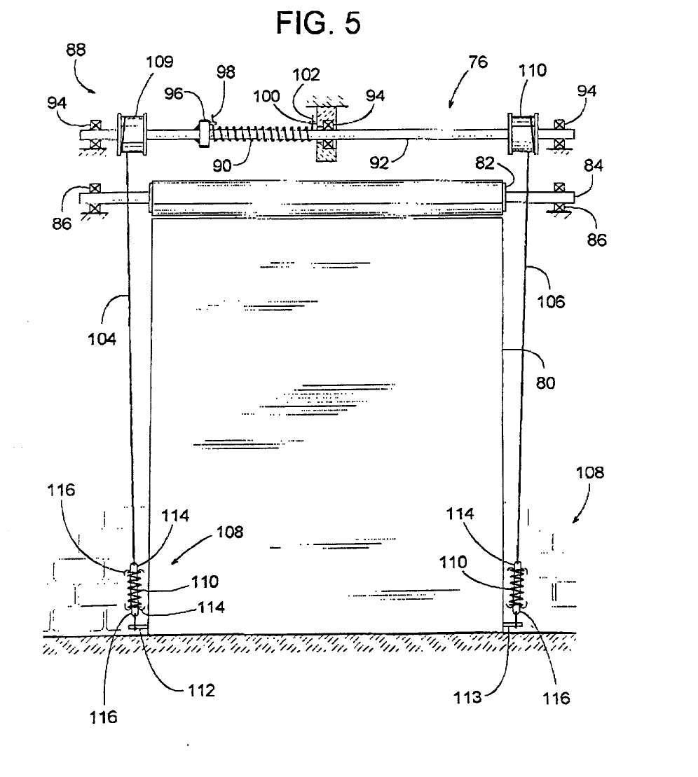

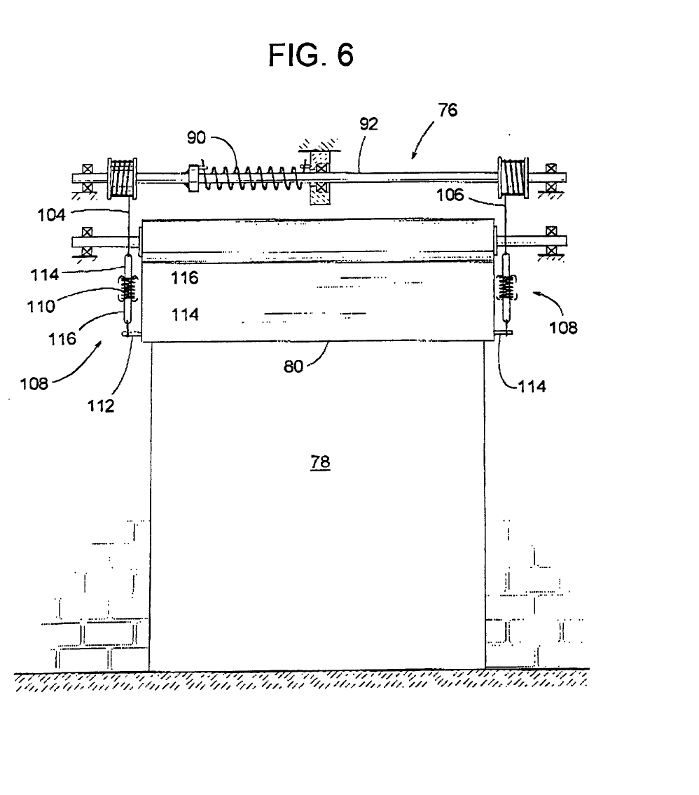

In another embodiment, a door 76 for use across a doorway 78 includes a pliable rollup door panel 80 that wraps around a roller 82 upon moving from its closed position of FIG. 5 to its open position of FIG. 6. Roller 82 includes a shaft 84 supported by bearings 86. To counteract the weight of panel 80, a counterbalance system 88 of door 76 includes a torsion spring 90 instead of suspended deadweights.

Torsion spring 90 applies a torque to a rotatable shaft 92, which is supported by bearings 94. The torque of spring 90 counteracts the torque that the door panel's weight applies to shaft 92.

Torsion spring 90 is disposed about shaft 92 with a spring retainer 96 holding one end 98 of spring 90 generally fixed to shaft 92, so end 98 rotates with the shaft. Another spring retainer 100 holds an opposite end 102 of spring 90 generally stationary, so the relative rotational displacement of retainers 96 and 100 determines the torque that spring 90 applies to shaft 92.

Door panel 80 creates its torque on shaft 92 by being suspended by cables 104 and 106, whose lower ends are coupled to the bottom edge of panel 80. The upper portion of cables 104 and 106 wrap around and connect to drums 109 and 110, which in turn are fixed to shaft 92. As door 80 moves to its open position, the torque created by the weight of door panel 80 decreases as more of the panel's weight becomes supported by roller 82 rather than by cables 104 and 106. To compensate for the changing tension in cables 104 and 106, torsion spring 90 relaxes or unloads as door 76 opens and tightens as door 76 closes. However, to help hold door 76 at its fully open position, torsion spring 90 may not necessarily relax to a state of zero-preload, but instead preferably maintains a certain amount of preload even when the door is fully open.

To help prevent cables 104 and 106 from becoming slack and entangled on their drums, door 76 is provided with a tensioner 108, such as a drawbar spring. Tensioner 108 provides a function similar to that of tensioner 14 in that they both maintain the tension in a cable above a threshold to help hold the cable against its take-up drum. However, unlike tensioner 14, tensioner 108 transmits the full tension of cables 104 and 106 even when door 76 is at or moving toward its open position. Tensioner 108 couples cables 104 and 106 to anchors 112 and 113, which extend from the lower edge of door panel 80. Tensioner 108 comprises a compression spring 110 contained between two wire frames 114 and 116, which are able to move relative to each other. Wire frames 114 connect to cables 104 and 106, and wire frames 116 connect to anchors 112 and 113. As the tension in cables 104 and 106 increases, wire frames 114 and 116 move apart to compress spring 110. When cables 104 and 106 carry an appreciable amount of the door panel's weight, as shown in FIG. 6, compression spring 110 bottoms out, whereby tensioner 108 operates in the first mode. However, when the bottom edge of panel 80 rests on the floor, as shown in FIG. 5, wire frames 114 and 116 move toward each other to place tensioner 108 in the second mode where compression spring 110 expands to take up slack that would otherwise exist in cables 104 and 106.

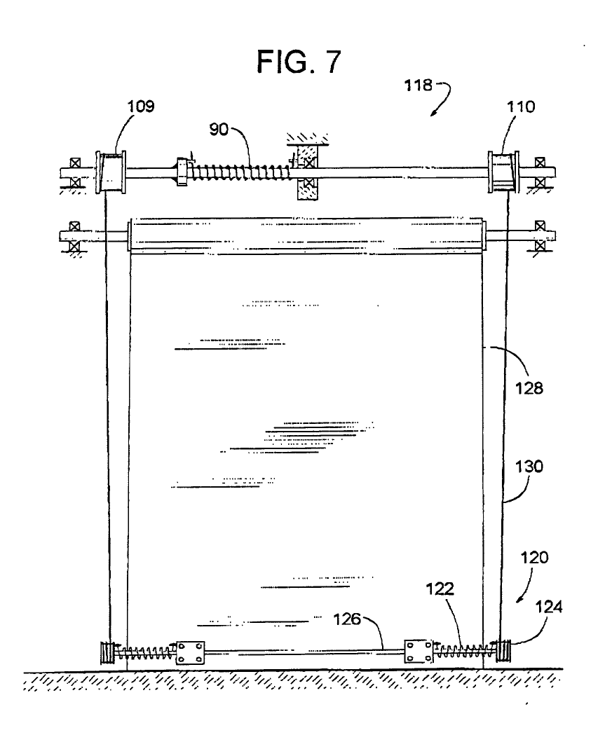

In a similar embodiment of a door 118, shown in FIG. 7, a tensioner 120 replaces tensioner 108. In this example, tensioner 120 includes a torsion spring 122 that urges a drum 124 to rotate about a shaft 126 mounted to the lower edge of a rollup door panel 128. The angular rotation of drum 124 is limited (i.e., a sufficient load on a cable 130 rotates drum 124 to a stopping point that places tensioner 120 in its first mode). The limited rotation of drum 124 allows cable 130, whose opposite ends wrap around and connect to drums 124 and 110, to help carry the weight of panel 128 as door 118 opens and closes. When the lower edge of door panel 128 rests on the floor, as shown in FIG. 7, the reduced load on cable 130 allows torsion spring 122 to rotate drum 124 about shaft 126. As drum 124 rotates in this second mode, it takes up the slack in cable 130.

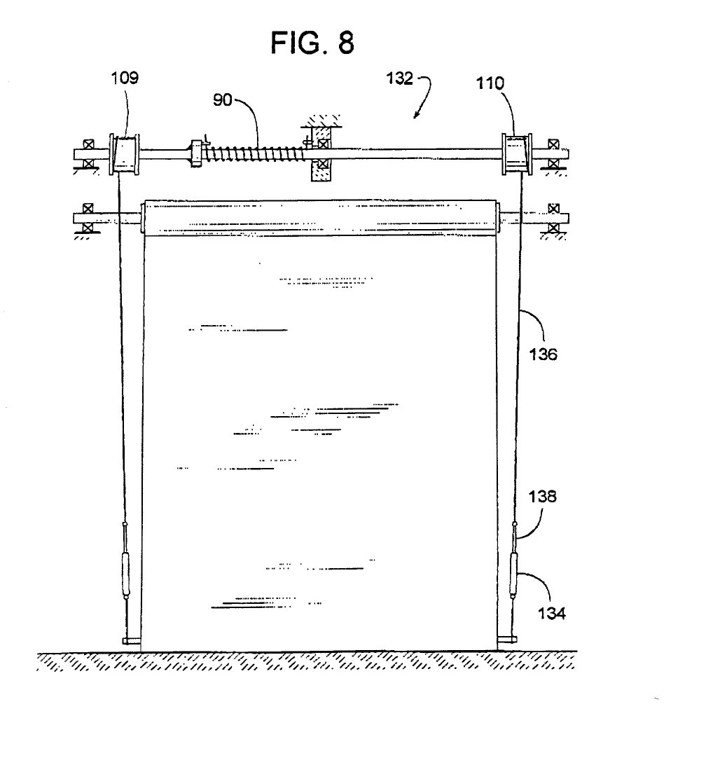

FIG. 8 shows a door 132 similar to door 76 of FIGS. 5 and 6; however, a tension-style gas spring 134 (i.e., gas spring 134 includes a normally retracted rod) replaces the drawbar spring of tensioner 108. When the tension in cable 136 decreases to a predetermined level, gas spring 134 retracts its rod 138 in an elastic manner to take up slack in cable 136.

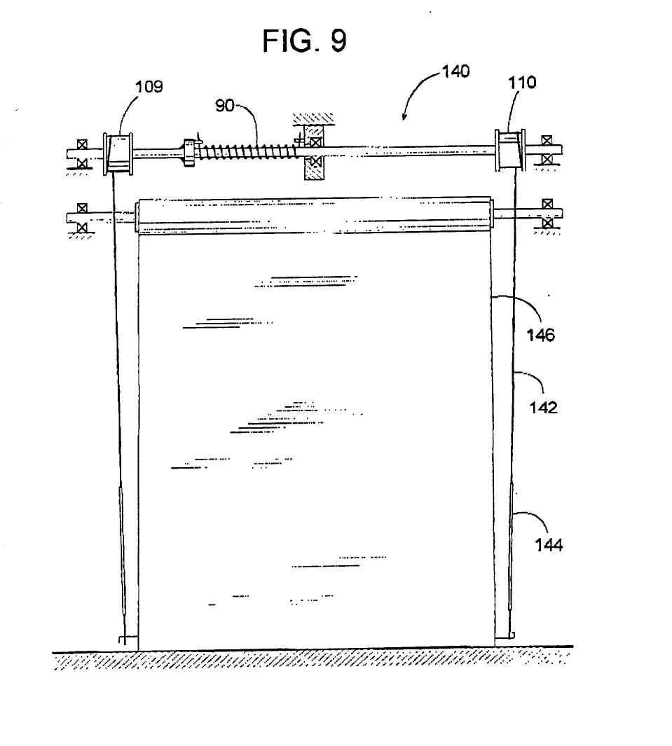

FIG. 9 shows yet another door 140 similar to door 76 of FIGS. 5 and 6; however, instead of tensioner 108, a cable 142 comprises an elastic cord 144. Cord 144 operates in its second mode to take up slack in cable 142 when the cable tension (dynamic load) is below a certain level. Above that limit, however, cord 144 reaches its maximum length of stretch and begins functioning as a generally inelastic member (i.e., in its first mode) and is able to help carry the weight of a door panel 146 as door 140 opens and closes.

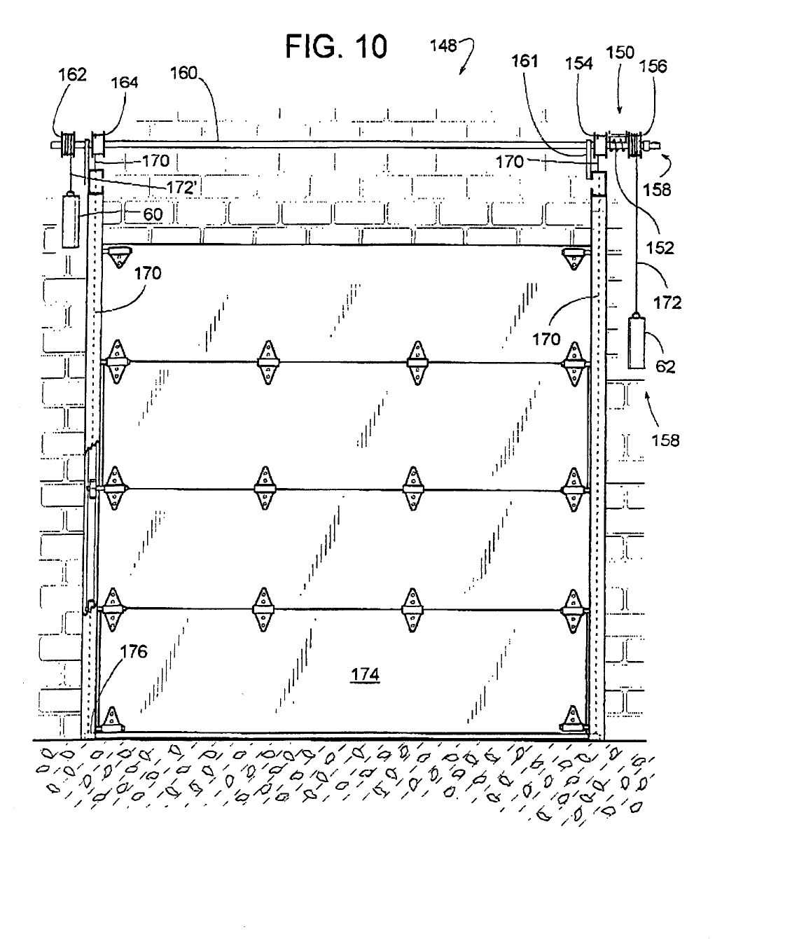

FIGS. 10-13 illustrate a door 148 similar to door 10 of FIGS. 1-4; however, tensioner 14 of door 10 is replaced by a tensioner 150, which comprises a torsion spring 152 that interacts with drums 154 and 156 of a counterbalance system 158.

To reduce the force required to lift the door panels to their open position, counterbalance system 158 comprises a bracket 161 that supports a rotatable shaft 160 to which three drums 162, 164 and 154 are fixed. A fourth drum 156 is allowed some rotation on shaft 160, but a pin 166 extending from drum 154 and a pin 168 on drum 156 engage each other to limit the rotation of drum 156 relative to drum 154 and shaft 160. The rotation of drum 156 about shaft 160 is limited to just less than 360-degrees due to the thickness of pins 166 and 168. Two cables 170 and 172 are wrapped around and fastened to drums 154 and 156 respectively. The lower ends of cables 170 are coupled to door panel 174 by way of an anchor 176. Another set of cables 172 and 172′ are wrapped around and fastened to drums 156 and 162 respectively. Deadweights 62 and 60 are suspended from the lower ends of cables 172 and 172′. Cables 172 and 172′ wrap around drums 156 and 162 in a direction opposite to that which cables 170 wrap around drums 154 and 164. As door 148 is moved between its open and closed positions, deadweights 62 and 60 hanging from cables 172 and 172′, and the door panels hanging from cables 170 create two opposing torques that are applied to shaft 160. With the two torques acting in opposite directions, the weight of the door panels and deadweights help cancel each other, which makes it easier to open and close the door.

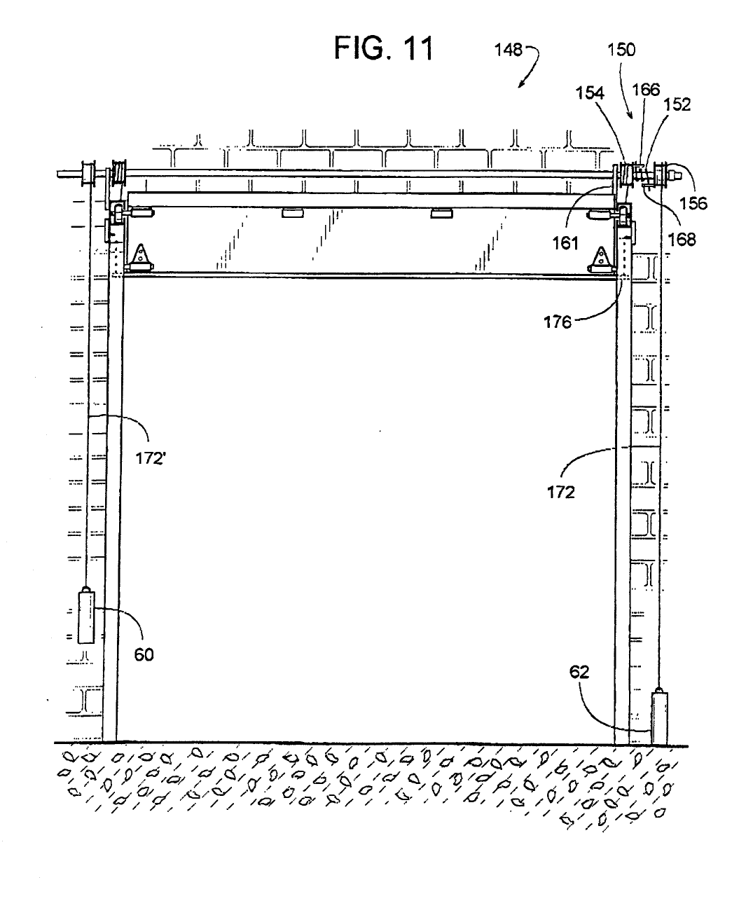

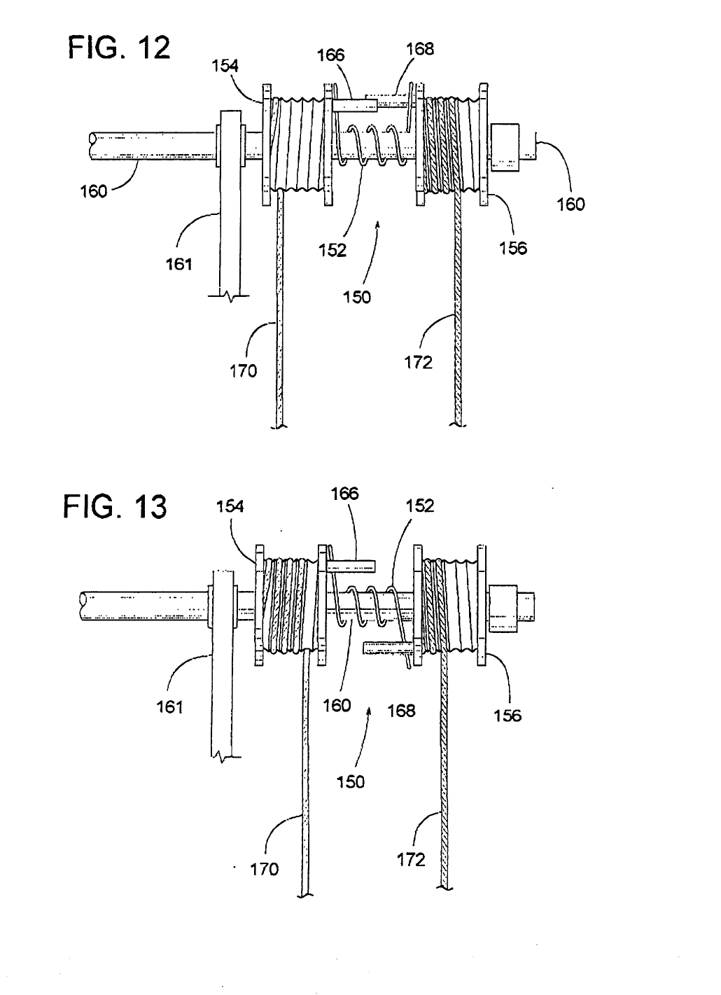

To help prevent cable slackness from allowing cable 172 to lift off of drum 156 or from allowing cable 170 to lift off drum 154, torsion spring 152 is installed around shaft 160 between drums 154 and 156. Opposite ends of spring 152 engage pins 166 and 168, as shown in FIGS. 12 and 13. Spring 152 urges drum 156 to rotate clockwise relative to drum 154 as viewed from the right of FIG. 12 or 13. Under normal door operation, cables 170 and 172 will carry sufficient tension to overcome the urging of spring 152. So, pins 166 and 168 will normally remain engaged, as shown in FIGS. 10 and 12, and drums 154 and 156, together, will follow the rotation of shaft 160. In normal operation, then, tensioner 150 operates in the first mode. However, if the dynamic load or tension in cables 170 or 172 falls below a predetermined level, torsion spring 152 will be able to overcome that tension and rotate drum 156 a certain degree relative to drum 154, as shown in FIGS. 11 and 13. The relative rotation of the drums allows the drums to take up slack in their respective cables. Under such a condition, tensioner 150 operates in its second mode.

Although the invention is described with reference to a preferred embodiment, it should be appreciated by those skilled in the art that various modifications are well within the scope of the invention. For example, the various disclosed tensioners may be coupled to one or more of the cables leading to a deadweight and/or a door panel, and may be installed at locations other than those illustrated in the examples. And tensioners described and illustrated with reference to a particular style of door is not necessarily limited to such a door, but rather may be readily adapted for use on other doors including, but not limited to sectional doors, roll-up doors, high-lift doors, horizontally storing doors, vertically storing doors, and various combinations thereof. For example, for roller doors like that shown in FIG. 5, the counterbalance system is often a counterweight system with the cable drums being mounted on the same shaft 84 as roll tube 82. For embodiments that include a deadweight, the quantity of deadweights can be less or significantly more than the quantities shown and described. Moreover, the shape, size and location of the deadweights may vary significantly and 25 still remain well within the scope of the invention. Therefore, the scope of the invention is to be determined by reference to the claims that follow.

We claim:

1. A door, comprising:
a door panel;
a counterbalance system that helps support the weight of the door panel, wherein the counterbalance system includes a flexible elongated member able to carry a tensile force that counters at least some of the door panel's weight; and
a tensioner coupled to the counterbalance system and being adapted to take up slack in the flexible elongated member.

2. The door of claim 1, wherein the flexible elongated member comprises a cable.

3. The door of claim 1, wherein the counterbalance system includes a deadweight that moves downward as the door opens.

4. The door of claim 1, wherein the counterbalance system includes a main torsion spring that relaxes as the door opens.

5. The door of claim 1, wherein the tensioner is coupled to the flexible elongated member.

6. The door of claim 3, further comprising: a rotatable drum, wherein the flexible elongated member extends between the rotatable drum and the deadweight, and the tensioner is disposed between the deadweight and the rotatable drum.

7. The door of claim 6, wherein the tensioner moves downward with the deadweight as the door opens.

8. The door of claim 6, wherein the tensioner is adjacent the deadweight.

9. The door of claim 1, further comprising:
a rotatable drum; and
an anchor coupled to the door panel, wherein the flexible elongated member extends between the rotatable drum and the anchor, and the tensioner is disposed between the rotatable drum and the anchor.

10. The door of claim 9, wherein the tensioner moves upward with the door panel as the door opens.

11. The door of claim 9, wherein the tensioner is adjacent the anchor.

12. The door of claim 1, wherein the tensioner includes a resilient member.

13. The door of claim 12, wherein the resilient member is a tension spring.

14. The door of claim 12, wherein the resilient member is a compression spring.

15. The door of claim 12, wherein the resilient member is a torsion spring.

16. The door of claim 12, wherein the resilient member is a gas spring.

17. The door of claim 12, wherein the resilient member is an elastic cord that is an integral part of the flexible elongated member itself.

18. The door of claim 1, wherein the door panel is a plurality of pivotally interconnected sections.

19. The door of claim 1, wherein the door panel is a pliable panel and coils about itself as the door opens.

20. A door, comprising:
a rotatable drum;
a door component;
a flexible elongated member wrapped about the rotatable drum and coupled to the door component; and
a resilient member attached to the flexible elongated member, wherein the flexible elongated member and the resilient member carry at least part of the door component's weight and transmits at least part of the door component's weight to the rotatable drum.

21. The door of claim 20, wherein the door component is a door panel.

22. The door of claim 21, wherein the door panel is a plurality of pivotally interconnected sections.

23. The door of claim 21, wherein the door panel is a pliable panel and coils about itself as the door opens.

24. The door of claim 20, wherein the door component is a deadweight that moves downward as the door opens

25. The door of claim 20, wherein the flexible elongated member comprises a cable.

26. The door of claim 20, further comprising a counterbalance system includes a main torsion spring that relaxes as the door opens.

27. The door of claim 20, further comprising: a rotatable drum, wherein the flexible elongated member extends between the rotatable drum and the door component, and the resilient member is disposed between the door component and the rotatable drum.

28. The door of claim 20, wherein the resilient member moves downward with the door component as the door opens.

29. The door of claim 20, wherein the resilient member is adjacent the door component.

30. The door of claim 20, wherein the resilient member moves upward with the door component as the door opens.

31. The door of claim 20, wherein the resilient member is a tension spring.

32. The door of claim 20, wherein the resilient member is a compression spring.

33. The door of claim 20, wherein the resilient member is a torsion spring.

34. The door of claim 20, wherein the resilient member is a gas spring.

35. The door of claim 20, wherein the resilient member is an elastic cord that is an integral part of the flexible elongated member itself.

36. A door comprising:
a flexible elongated member;
a door component suspended from the flexible elongated member, wherein the door component creates a dynamic load that may vary above and below a predetermined load, wherein above the predetermined load the dynamic load is sufficient to maintain the flexible elongated member taut; and
a resilient member coupled to the flexible elongated member and selectively operable in a first mode and a second mode in response to the magnitude of the dynamic load, wherein the resilient member operates in the first mode when the dynamic load exceeds the predetermined load and operates in the second mode when the dynamic load is below the predetermined load, whereby the resilient member in the second mode is able to maintain the tension in the flexible elongated member above a threshold level even though the dynamic load is below the predetermined load.

37. The door of claim 36, wherein the door component is a door panel.

38. The door of claim 37, wherein the door panel is a plurality of pivotally interconnected sections.

39. The door of claim 37, wherein the door panel is a pliable panel and coils about itself as the door opens.

40. The door of claim 36, wherein the door component is a deadweight that moves downward as the door opens

41. The door of claim 36, wherein the flexible elongated member comprises a cable.

42. The door of claim 36, further comprising a counterbalance system includes a main torsion spring that relaxes as the door opens.

43. The door of claim 36, further comprising: a rotatable drum, wherein the flexible elongated member extends between the rotatable drum and the door component, and the resilient member is disposed between the door component and the rotatable drum.

44. The door of claim 36, wherein the resilient member moves downward with the door component as the door opens.

45. The door of claim 36, wherein the resilient member is adjacent the door component.

46. The door of claim 36, wherein the resilient member moves upward with the door component as the door opens.

47. The door of claim 36, wherein the resilient member is a tension spring.

48. The door of claim 36, wherein the resilient member is a compression spring.

49. The door of claim 36, wherein the resilient member is a torsion spring.

50. The door of claim 36, wherein the resilient member is a gas spring.

51. The door of claim 36, wherein the resilient member is a n elastic cord that is an integral part of the flexible elongated member itself.
